(19) United States
(12) Patent Application Publication
(10) Pub. No.: US 2011/0019156 A1
(43) Pub. Date: Jan. 27, 2011

(54) PROJECTION SYSTEM AND METHOD THEREOF

(75) Inventors: Chih-Chung Chang, Hsinchu (TW); Chia-Pin Lin, Hsinchu (TW); Yung-Chu Lin, Hsinchu (TW); Hsin-Mao Chung, Hsinchu (TW)

Correspondence Address: J C PATENTS, 4 VENTURE, SUITE 250, IRVINE, CA, 92618, US

(73) Assignee: YOUNG OPTICS INC., Hsinchu (TW)

(21) Appl. No.: 12/789,872

(22) Filed: May 28, 2010

(30) Foreign Application Priority Data
Jul. 23, 2009 (TW) 98124894

(51) Int. Cl. G03B 21/14; G03B 21/00

(52) U.S. Cl. 353/31; 353/121

(57) ABSTRACT

A projection system and a method thereof are provided. The projection method includes the following steps. First, a processing module of an electronic device acquires a process ID of an application program via an operating system of the electronic device. Next, the processing module extracts display data corresponding to a window of the application program from a frame buffer of the electronic device stepwise with a predetermined frequency. Next, the processing module produces a plurality of pictures based on the extracted display data with the predetermined frequency. Next, the processing module transmits the pictures to a projector according to a predetermined transmission protocol. Finally, the projector projects the pictures sequentially.

### CROSS-REFERENCE TO RELATED APPLICATION

This application claims the priority benefit of Taiwan application serial no. 98124894, filed on Jul. 23, 2009. The entirety of the above-mentioned patent application is hereby incorporated by reference herein and made a part of this specification.

### BACKGROUND OF THE INVENTION

1. Field of the Invention

The invention relates to a projection method. More particularly, the invention relates to a projection method adapted to a multimedia projector.

2. Description of Related Art

A projection apparatus may project images onto a larger screen to facilitate more people watching the images displayed on the screen at the same time. Therefore, the projection apparatus is generally used in public places such as companies, schools, etc. Moreover, as family-used display products trend to be large-scaled, the projection apparatus is also widely used in general families, and becomes a commonly used electronic product in people's daily life.

With development of technology, electronic products are developed to have high speed, high performance, and design features of lightness, slimness, shortness and smallness. In this case, multimedia pico projectors (or mini projectors) have become a main stream in the market of personal digital products. Since resolution of a current pico projector is far more less than the resolution of a general computer, and a projection display range thereof is small, if an image of a whole screen is entirely projected according to a projection method of a conventional projector, objects in a projected image are not easy to be identified, so that the current pico projector is inconvenient for utilization.

Taiwan publication No. 200729033 discloses a method for displaying objects of a windows operating system to a plurality of display devices, Taiwan publication No. 200823862 discloses a device and a method for synchronously displaying image data through a universal serial bus (USB), and Taiwan publication No. I269583 discloses a projection system that transmits data to be projected through a wireless transmission method. Moreover, an EPSON EP-1715 projector may project images displayed on a monitor. The above patents and products provide devices and methods for projecting a whole screen image and transmitting projection data, though the problems of a low resolution and a small projection display range of the multimedia pico projector are still not resolved.

### SUMMARY OF THE INVENTION

The invention provides a projection system and a projection method, and a problem of difficult identifying objects one an image due to an inadequate display range and a low resolution of a projector while projecting a whole screen image may be avoided.

Additional aspects and advantages of the invention may be set forth in the description of the techniques disclosed in the invention.

To achieve at least one of aforementioned advantages, an embodiment of the invention provides a projection method adapted to project a window of an application program executed by an electronic device. The projection method includes the following steps. Firstly, a process ID of the application program is obtained through an operating system of the electronic device. Next, display data corresponding to the window is extracted stepwise with a predetermined frequency from a frame buffer of the electronic device according to the process ID. Afterwards, a plurality of pictures is produced with the predetermined frequency according to the extracted display data of the window. Next, the pictures are transmitted to a projector according to a predetermined transmission protocol. Finally, the projector sequentially projects the pictures.

In an embodiment of the invention, the projection method further includes adjusting a size of the window according to a predetermined resolution before the display data of the window is extracted.

The invention provides a projection system including a projector having a first connection port and an electronic device coupled to the projector. The electronic device includes a second connection port, a processing module, a display and a frame buffer. The second connection port is coupled to the first connection port of the projector. The processing module is capable of executing an operating system, a first application program, and a second application program, wherein the second application program is capable of obtaining a process ID of the first application program through the operating system. The display is capable of displaying an image. Moreover, the frame buffer is coupled to the processing module, and is capable of saving display data of the image. When the processing module executes the second application program, the processing module extracts display data corresponding to a window of the first application program from the frame buffer stepwise with a predetermined frequency according to the process ID, and the processing module produces a plurality of pictures with the predetermined frequency according to the extracted display data of the window and transmits the pictures to the projector through the first connection port and the second connection port according to a predetermined transmission protocol, so that the projector projects the pictures sequentially.

In an embodiment of the invention, before the processing module extracts the display data of the window, the processing module adjusts a size of the window according to a predetermined resolution.

In an embodiment of the invention, the processing module obtains coordinates and a size of the window on the image according to the process ID, and obtains a memory address of the display data of the window in the frame buffer, and the processing module extracts the display data corresponding to the window from the frame buffer stepwise with the predetermined frequency according to the obtained coordinates, the size, and the memory address.

In an embodiment of the invention, the processing module includes a processor and a graphics acceleration chip, and the processor extracts the display data of the window through the graphics acceleration chip and generates the pictures.

In an embodiment of the invention, each of the first connection port and the second connection port is a universal serial bus (USB) port.

In an embodiment of the invention, the pictures are compressed pictures.

In an embodiment of the invention, the projector decompresses the pictures.

In an embodiment of the invention, a format of the pictures is JPEG, PNG, PCX, GIF, ASF, AVI or MPEG4.

In an embodiment of the invention, the pictures are not compressed.

In an embodiment of the invention, a format of the pictures is bitmap, RGB or YUV.

In the above embodiments of the invention, by projecting a window of a single application program, a problem of difficult to identify objects on an image due to an inadequate display range and a low resolution of a projector when a whole screen image is projected may be avoided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a projection system according to an embodiment of the invention.

FIG. 2 is a schematic diagram illustrating a situation when a projection system of FIG. 1 projects images.

FIG. 3 is a block diagram illustrating a projection system according to another embodiment of the invention.

FIG. 4 is a schematic diagram illustrating a situation when a projection system projects images according to another embodiment of the invention.

FIG. 5 is a flowchart illustrating a projection method according to an embodiment of the invention.

FIG. 6 is a flowchart illustrating a projection method according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

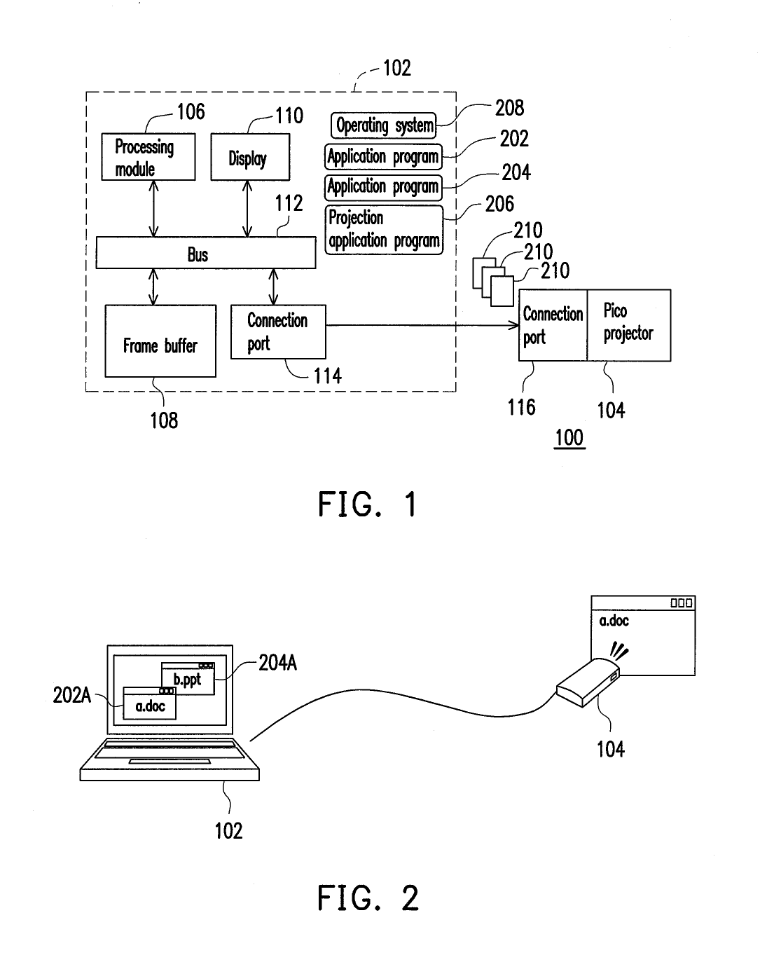

FIG. 1 is a block diagram illustrating a projection system according to an embodiment of the invention. FIG. 2 is a schematic diagram illustrating a situation when the projection system of FIG. 1 projects images. Referring to FIG. 1 and FIG. 2, the projection system 100 includes an electronic device 102 and a pico projector 104. The electronic device 102 outputs image data to the pico projector 104, so that the pico projector 104 projects an image of a single application program. For example, when a display 110 of the electronic device 102 displays a window 202A and a window 204A simultaneously, the pico projector 104 may project a single window 202A or 204A, as shown in FIG. 2. Therein, the windows 202A and 204A respectively correspond to an application program 202 and an application program 204.

The electronic device 102 includes a processing module 106, a frame buffer 108, a display 110, a bus 112, and a connection port 114. Therein, the processing module 106, the frame buffer 108, the display 110 are mutually coupled through the bus 112. The frame buffer 108 is capable of temporarily saving display data to be displayed by the display 110 and provide the display data to the display 110. On the other hand, the pico projector 104 includes a connection port 116, and the pico projector 104 is coupled to the connection port 114 of the electronic device 102 through the connection port 116. Therein, the electronic device 102 is, for example, a computer, a mobile phone or a personal digital assistant (PDA) . . . , and the display 110 is, for example, a liquid crystal display (LCD).

The pico projector 104 may project any single window. Taking the window 202A as an example, when the pico projector 104 projects the window 202A of the application program 202, the processing module 106 executes a projection application program 206 to obtain a process ID (PID) corresponding to the application program 202 through the operating system 208. The processing module 106 identifies different application programs according to the PID, each of the executed application program corresponds to a PID, and a different application program corresponds to a different PID. Thereafter, the processing module 106 extracts display data corresponding to the window 202A of the application program 202 from the frame buffer 108 stepwise with a predetermined frequency according to the PID of the application program 202, wherein the predetermined frequency is, for example, 30 times per second. In other words, the processing module 106 stepwise extracts the display data of the window 202A with a sampling frequency of 30 times per second, i.e. the processing module 106 extracts the display data of the window 202A from the frame buffer 108 every one-thirty second.

Moreover, before extracting the display data of the window 202A, the processing module 106 adjusts a size of the window 202A according to a predetermined resolution. In an embodiment of the invention, the predetermined resolution is, for example, a resolution of the pico projector 104. The processing module 106 produces a plurality of pictures 210 with the predetermined frequency (for example, 30 times per second) according to the extracted display data of the window 202A. Then, the processing module 106 transmits the pictures 210 from the electronic device 102 to the pico projector 104 through the connection port 114 and the connection port 116 according to a predetermined transmission protocol, wherein a file format of the pictures 210 produced by the processing module 106 is, for example, bitmap, RGB or YUV. Thereafter, the pico projector 104 sequentially projects the received pictures 210. Therefore, a user may perform a presentation or watch videos at various places through the projection system 100. Since the pico projector 104 projects the window of the single application program, the images projected by the pico projector 104 may clearly present details of the window of the application program.

In the embodiment, the connection port 114 and the connection port 116 are both universal serial bus (USB) ports, and the predetermined transmission protocol is a USB transmission protocol. An advantage of using the USB as a transmission interface is that the pico projector 104 does not need an additional video controller used for a video graphics array (VGA) interface, a digital visual interface (DVI) or a high definition multimedia interface (HDMI), so that the cost of the pico projector 104 may be saved, and portability of the pico projector 104 may be achieved. Though the USB is taken as an example, the invention is not limited thereto, and other transmission interfaces (for example, a wireless network or a bluetooth transmission interface . . . ) may also be selected to serve as a connection interface between the electronic device 102 and the pico projector 104 according to an actual demand.

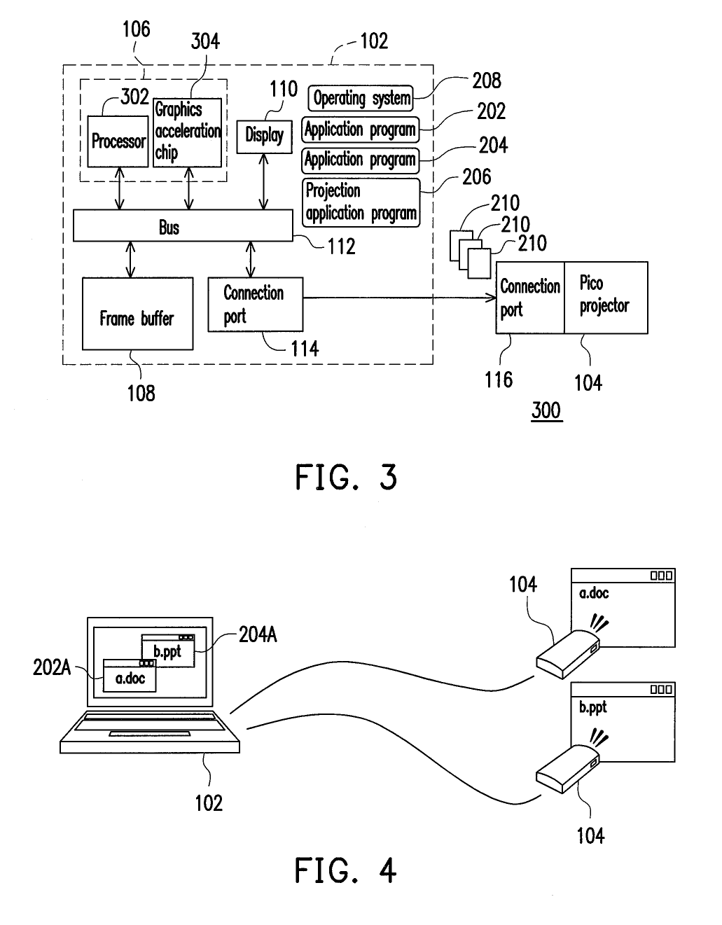

In detail, FIG. 3 is a block diagram illustrating a projection system according to another embodiment of the invention. Referring to FIG. 3, in the embodiment, the processing module 106 of the projection system 300 includes a processor 302 and a graphics acceleration chip 304. When the user wants to project one of the application programs executed by the processor 302, the user may press a specific combination key or button (not illustrated) to enable the processor 302 executing the projection application program 206. For example, the user may activate the projection application program 206 by pressing a right button of a mouse to open a pull-down menu or by pressing a predetermined hot key, so as to select a window of the application program to be projected. For example, the user selects the window 202A of the application program 202. After the user selects the window 202A to be projected, the processor 302 obtains a PID which corresponds to the application program 202 through the operating system 208, coordinates and a size of the window 202A of the application program 202 on the screen image of the display 110 according to the PID, and a memory address of display data of the window 202A in the frame buffer 108. The processor 302 extracts the display data from the frame buffer 108 stepwise with the predetermined frequency (for example, 30 times per second) through the graphics acceleration chip 304 according to the obtained coordinates, the size, and the memory address of the display data of the window 202A in the frame buffer 108 and produces a plurality of pictures.

Moreover, when the size of the window 202A exceeds the aforementioned predetermined resolution, before the processor 302 extracts the display data of the window 202A, the user may change the size of the window 202A via the projection application program 206, zoom in/out or rotate the window 202A to ensure that the size of the window 202A matches a display aspect ratio of the pico projector 104, so that the pictures projected by the pico projector 104 may satisfy a viewing demand of the user. For example, a length or width of the window 202A may be adjusted to meet the display aspect ratio of the pico projector 104 or the size of the window 202A may be adjusted to the resolution of the pico projector 104.

Moreover, when the extracted display data is too large, the processing module 106 may further compress the picture to reduce a file size of the picture. For example, the processing module 106 may convert the format of the picture from bitmap into JPEG with a relatively small data amount. Besides JPEG format, the format of the compressed picture may also be PNG, PCX or GIF. Additionally, a streaming compression may be performed to the extracted picture data, so as to save the picture data as ASF, AVI or MPEG4 video format. Moreover, any other customized file decompression method may also be applied, and a transmitter and a receiver of the projection system 300 apply a same method for compressing/decompressing. By this way, when the electronic device 102 transmits a picture to the pico projector 104, a transmitted data amount between the connection ports 114 and 116 may be effectively reduced. Thereafter, the pico projector 104 decompresses the received picture and projects an image corresponding to the window 202A of the application program 202.

In the embodiment of FIG. 3, the processor 302 extracts the display data from the frame buffer 108 stepwise with the predetermined frequency (for example, 30 times per second) through the graphics acceleration chip 304, and produces a plurality of pictures. Since the processor 302 may hand over a part of image processing tasks to the graphics acceleration chip 304, a load of the processor 302 may be reduced. In some embodiments, if a computation amount of the graphics acceleration chip 304 is excessive, a computing function of the processor 302 may still be used to support the graphics acceleration chip 304, so that operation of the projection system 300 may be more efficiency.

FIG. 4 is a schematic diagram illustrating a situation when a projection system projects images according to another embodiment of the invention. Referring to FIG. 4, in one embodiment of the invention, the electronic device 102 may be simultaneously connected to a plurality of pico projectors 104 to facilitate a user's utilization. For example, the electronic device 102 of FIG. 4 is connected to two pico projectors 104 and the pico projectors 104 respectively projecting the images of the window 202A or the window 204A.

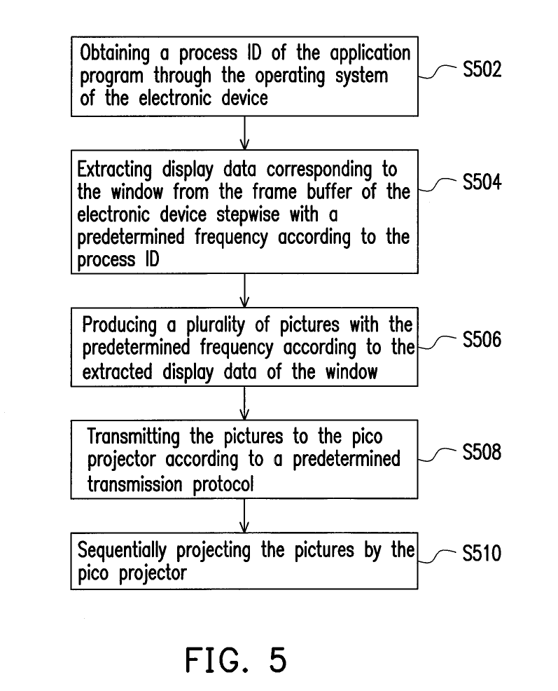

FIG. 5 is a flowchart illustrating a projection method according to an embodiment of the invention. Referring to FIG. 5 and FIG. 1, take the window 202A projected by the pico projector 104 for example, the processing module 106 first obtains the PID of the application program 202 through the operating system 208 (step S502). After the PID is obtained, the processing module 106 obtains the coordinates and the size of the window 202A on the screen image of the display 110 according to the PID, and obtains the memory address of the display data of the window 202A in the frame buffer 108. Next, the processing module 106 extracts the display data of the window 202A from the frame buffer 108 stepwise with the predetermined frequency according to the PID of the application program 202 (step S504). Next, the processing module 106 produces a plurality of pictures 210 with the predetermined frequency according to the extracted display data of the window 202A (step S506). Wherein, the predetermined frequency may be adjusted according to a sensitivity of human eyes for the pictures. Generally, when the pictures are displayed with a frequency of 30 pictures per second, the human eyes may not sense discontinuity of the pictures. Therefore, the predetermined frequency is set to 30 times per second, but the invention is not limited thereto.

Next, the processing module 106 transmits the pictures 210 to the pico projector 104 according to a predetermined transmission protocol (step S508). The transmission interface between the electronic device 102 and the pico projector 104 is diversified, such as USB transmission interface, wireless network or bluetooth transmission interface . . . . Finally, the pico projector 104 projects the pictures 210 sequentially (step S510).

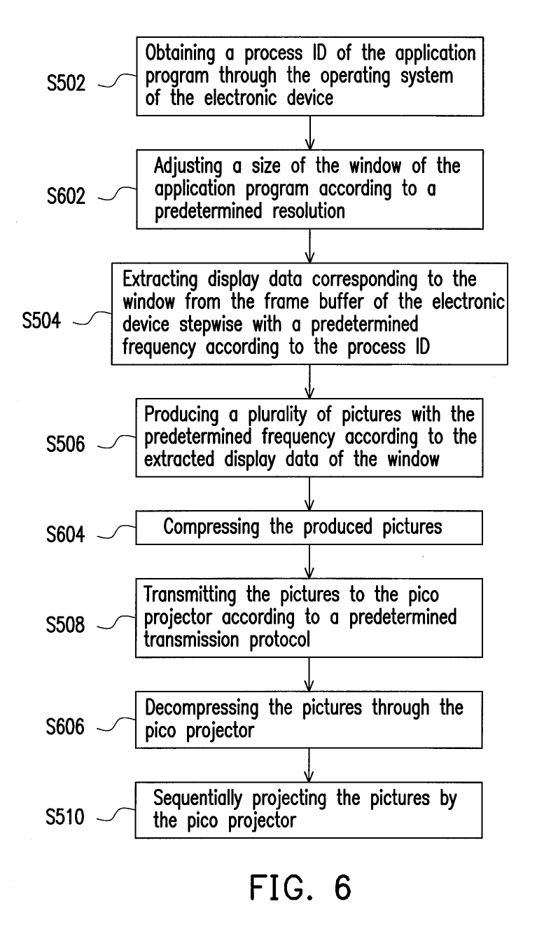

Since the size of the window 202A displayed on the screen may not match the resolution of the pico projector 104 or the picture file transmitted by the electronic device 102 may be too large to transmit the data at a regular speed and the above-situations may confuse the user. Therefore, the projection method of the embodiment of the invention further includes other steps. FIG. 6 is a flowchart illustrating a projection method according to another embodiment of the invention. Referring to FIG. 6 and FIG. 1, a difference between the embodiment and the embodiment of FIG. 5 is that the projection method of the embodiment further includes steps S602, S604, and S606. In the step S602, the processing module 106 adjusts the size of the window 202A according to the predetermined resolution, and the size of the window 202A may be adjusted via the projection application program 206. Moreover, in the step S604, the processing module 106 may compress the pictures 210 to convert the format of the pictures 210 into a file format with relatively small data amount (for example, from bitmap to JPEG), so as to reduce a data transmission amount between the electronic device 102 and the pico projector 104. Next, in the step S606, the pico projector 104 decompresses the compressed pictures. Though in the embodiment, the steps S506 and S604 are executed sequentially to produce the compressed pictures, the invention is not limited thereto. For example, in another embodiment of the invention, the step S604 may be omitted, and in the step S506, the processing module 106 may produce the compressed pictures according to the extracted display data of the window.

In summary, in the aforementioned embodiment of the invention, the display data of the window corresponding to the application program may be extracted from the frame buffer according to the PID of the application program, so as to generate and transmit a plurality of pictures to the pico projector, so that the pico projector projects a window of a single application program. Therefore, the image projected by the pico projector may clearly present details of the window of the aforementioned application program.

Moreover, the projection system and projection method of the invention at least have the following advantages:
1. The pico projector may project the image data of the application program of the electronic device without transmitting other image data, so that the amount of transmitted data may be reduced.
2. The graphics acceleration chip may be used to compute the pictures or video signals of the application program, so as to reduce a load of the processor.
3. The electronic device may be connected to a plurality of pico projectors, so that the performance and convenience of the projection system are improved.
4. Based on image processing such as zooming in/out, rotating or changing the aspect ratio the window image of the application program, the window image with a size greater than the resolution of the pico projector may still be integrally displayed on the projection image.
5. Even if the projected window of the application program is moved, a content of the projection image is not influenced.
6. The pico projector may not need an additional video controller, so that portability of the pico projector is achieved, and a cost thereof is reduced.

The foregoing description of the preferred embodiments of the invention has been for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection method, adapted to project a window of an application program executed by an electronic device, the projection method comprising the following steps:
obtaining a process ID of the application program through an operating system of the electronic device;
extracting display data corresponding to the window from a frame buffer of the electronic device stepwise with a predetermined frequency according to the process ID;
producing a plurality of pictures with the predetermined frequency according to the extracted display data of the window;
transmitting the pictures to a projector according to a predetermined transmission protocol; and
sequentially projecting the pictures by the projector.

2. The projection method as claimed in claim 1, further comprising:
adjusting a size of the window according to a predetermined resolution before the display data of the window is extracted.

3. The projection method as claimed in claim 1, wherein the step of extracting the display data corresponding to the window from the frame buffer stepwise with the predetermined frequency comprises:
obtaining coordinates and a size of the window displayed on a display of the electronic device according to the process ID, and obtaining a memory address of the display data of the window in the frame buffer; and
extracting the display data corresponding to the window from the frame buffer stepwise with the predetermined frequency according to the obtained coordinates, the size, and the memory address.

4. The projection method as claimed in claim 1, wherein the electronic device comprises a graphics acceleration chip, and the display data of the window is extracted through the graphics acceleration chip.

5. The projection method as claimed in claim 1, wherein the electronic device has a first universal serial bus, port, and the projector has a second universal serial bus port, the second universal serial bus port is coupled to the first universal serial bus port, and the pictures are transmitted to the projector through the first universal serial bus port and the second universal serial bus port.

6. The projection method as claimed in claim 1, wherein the pictures are compressed.

7. The projection method as claimed in claim 6, further comprising:
decompressing the pictures through the projector.

8. The projection method as claimed in claim 6, wherein a format of the pictures is JPEG, PNG, PCX, GIF, ASF, AVI, or MPEG4.

9. The projection method as claimed in claim 1, wherein the pictures are not compressed.

10. The projection method as claimed in claim 9, wherein a format of the pictures is bitmap, RGB or YUV.

11. A projection system, comprising:
a projector having a first connection port; and
an electronic device, coupled to the projector, the electronic device comprising:
a second connection port coupled to the first connection port of the projector;
a processing module capable of executing an operating system, a first application program, and a second application program, wherein the second application program is capable of obtaining a process ID of the first application program through the operating system;
a display capable of displaying an image; and
a frame buffer coupled to the processing module, and capable of saving display data of the image,
wherein when the processing module executes the second application program, the processing module extracts display data corresponding to a window of the first application program from the frame buffer stepwise with a predetermined frequency according to the process ID, and the processing module produces a plurality of pictures with the predetermined frequency according to the extracted display data of the window and transmits the pictures to the projector through the first connection port and the second connection port according to a predetermined transmission protocol, such that the projector projects the pictures sequentially.

12. The projection system as claimed in claim 11, wherein before the processing module extracts the display data of the window, the processing module adjusts a size of the window according to a predetermined resolution.

13. The projection system as claimed in claim 11, wherein the processing module obtains coordinates and a size of the window on the image according to the process ID and obtains a memory address of the display data of the window in the frame buffer, and the processing module extracts the display data corresponding to the window from the frame buffer stepwise with the predetermined frequency according to the obtained coordinates, the size, and the memory address.

14. The projection system as claimed in claim 11, wherein the processing module comprises a processor and a graphics acceleration chip, and the processor extracts the display data of the window through the graphics acceleration chip and generates the pictures.

15. The projection system as claimed in claim 11, wherein the first connection port and the second connection port are respectively a universal serial bus port.

16. The projection system as claimed in claim 11, wherein the pictures are compressed.

17. The projection system as claimed in claim 16, wherein the projector decompresses the pictures.

18. The projection system as claimed in claim 16, wherein a format of the pictures is JPEG, PNG, PCX, GIF, ASF, AVI or MPEG4.

19. The projection system as claimed in claim 11, wherein the pictures are not compressed.

20. The projection system as claimed in claim 19, wherein a format of the pictures is bitmap, RGB or YUV.
